(19) United States
(12) Patent Application Publication
(10) Pub. No.: US 2013/0194189 A1
(43) Pub. Date: Aug. 1, 2013

(54) MOBILE COMPUTING DEVICES CAPABLE OF AMBIDEXTROUS OPERATION

(71) Applicants: Myung Lee, Penfield, NY (US); Mark Benoit, Rochester, NY (US)

(72) Inventors: Myung Lee, Penfield, NY (US); Mark Benoit, Rochester, NY (US)

(73) Assignee: HARRIS CORPORATION, Melbourne, FL (US)

(21) Appl. No.: 13/359,850

(22) Filed: Jan. 27, 2012

(51) Int. Cl. G06F 3/02; G09G 5/00

(52) U.S. Cl. 345/169; 345/156

(57) ABSTRACT

Mobile computing devices such as tablet computers can include multiple input devices mounted on a housing. The input devices are arranged in a first array located near a first side of the housing, and in a second array that is substantially identical to the first array and is located near a second side of the housing. Each of the input devices is operable to generate an output when actuated. The output of each input device corresponds to a function. The computing devices are configured so that each of the input devices in the first array is functionally equivalent to a corresponding one of the input devices located at the same relative location the second array, so that the functions can be activated by the user using either the left or right hand regardless of how the mobile computing device is being held.

### BACKGROUND OF THE INVENTION

1. Statement of the Technical Field

The inventive arrangements relate to mobile computing devices such as tablet computers.

2. Description of Related Art

Mobile computing devices, such as tablet computers or tablets, are commonly operated while being held in one or both hands of a user. Tablets typically include a housing, and a display mounted on the housing. Tablets may include software and sensors that cause the visual output of the display to appear right side up to the user, regardless of the orientation in which the tablet is held.

Tablets and other mobile computing devices can include input devices, such as keys, that permit the user to enter inputs corresponding to specific functions. For example, tablets can be equipped with mechanical or capacitive keys that permit the user to enter functional inputs such as return and screen-refresh commands, and inputs that facilitate movement of a cursor around an image on the display. The keys are usually located near a side of the tablet, so that the user can manipulate the keys using a thumb or other finger of one hand while holding the tablet with that hand.

A user may prefer to operate the keys or other input devices using the left or right hand. This preference may be driven by the left or right-handedness of the user, i.e., a right-handed user may prefer to use his or her right hand to actuate the keys because the user is right-handed, and vice-versa regarding left-handed users. At other times, a user may need to use the left or right hand because the other hand is occupied with another task or is otherwise unavailable to actuate the keys or other input devices. For example, military personnel such as soldiers may need to hold weapon in one hand, while operating the tablet with the other hand. As another example, emergency responders such as a firefighters and paramedics may need to hold firefighting equipment, medical equipment, or a stretcher with one hand, while operating the tablet with the other hand.

In instances where the user prefers to, or must manipulate the keys or other input devices with the left or right hand, the user may need to rotate the tablet by up to 180° so that the user's left or right hand is located along the side of the tablet proximate the keys. For example, a user may need to remove the tablet from a protective case. If the user does not initially grasp the tablet along the side proximate the keys when reaching into the case, he or she may need to rotate the tablet by up to 180° after removing it from the case in order to properly grasp that side of the tablet. Moreover, it may be difficult or impossible to identify the side of the tablet proximate the keys when operating in darkness and other low or zero-visibility conditions.

The need for the user to rotate the tablet delays the ability of the user to begin using the tablet for its intended purpose. Such delays can potentially lead to adverse consequences under circumstances that may occur, for example, during combat, rescue, and firefighting operations.

### SUMMARY OF THE INVENTION

Mobile computing devices include a housing, a display mounted on the housing, a processor, and a first array of input devices. The input devices communicate with the processor, and are positioned near a first side of the housing. Each of the input devices operates to generate an output when it is actuated. The processor operates to associate the output of each of the input devices with a function.

The mobile computing devices also include a second array of the input devices. The input devices of the second array communicate with the processor, and are positioned near a second side of the housing. Each of the input devices in the second array operates to generate an output when it is actuated. The second array is substantially identical to the first array. The processor operates to associate the output of each of the input devices in the second array with a function that is the same as the function associated with the input device at the same relative location in the first array. Thus, the functions are activated by the user using either the left or right hand regardless of how the mobile computing device is being held.

In accordance with another aspect of the inventive concepts disclosed herein, mobile computing devices include a housing, a display mounted on the housing, and multiple input devices mounted on the housing. The input devices are arranged in a first array, and in a second array that is substantially identical to the first array. The first and second arrays are positioned on opposite sides of the display. Each of the input devices is operable to generate an output when actuated. The output of each input device corresponds to a function. The mobile computing device is configured so that each of the input devices in the first array is functionally equivalent to a corresponding one of the input devices located at the same relative location the second array.

In accordance with another aspect of the inventive concepts disclosed herein, methods for operating a mobile computing device include providing a functional input to the computing device by actuating a first input device of the computing device located proximate a right side of the computing device using a finger of the right hand while holding the computing device in a first orientation; and providing the same functional input to the computing device by actuating a second input device located proximate a left side on the computing device using a finger of the left hand while holding the computing device in the first orientation.

### BRIEF DESCRIPTION OF THE DRAWINGS

Embodiments will be described with reference to the following drawing figures, in which like numerals represent like items throughout the figures and in which:

FIG. 1 is a front view of a mobile computing device in the form of a tablet computer, oriented in a first landscape orientation;

FIG. 2 is a front view of the tablet computer shown in FIG. 1, oriented in a second landscape orientation angularly offset from the first landscape orientation by approximately 180°;

FIG. 3 is a front view of the tablet computer shown in FIGS. 1 and 2, oriented in the first landscape orientation, during left-handed operation thereof;

FIG. 4 is a front view of the tablet computer shown in FIGS. 1-3, oriented in the first landscape orientation, during right-handed operation thereof;

FIG. 5 is a front view of the tablet computer shown in FIGS. 1-4, oriented in the first portrait orientation;

FIG. 6 is a front view of the tablet computer shown in FIGS. 1-5, oriented in a second portrait orientation angularly offset from the first landscape orientation by approximately 180°;

FIG. 7 is a block diagram depicting electrical and electronic components of the tablet computer shown in FIGS. 1-6; and

FIG. 8 is a front view of an alternative embodiment of the tablet computer shown in FIGS. 1-7.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

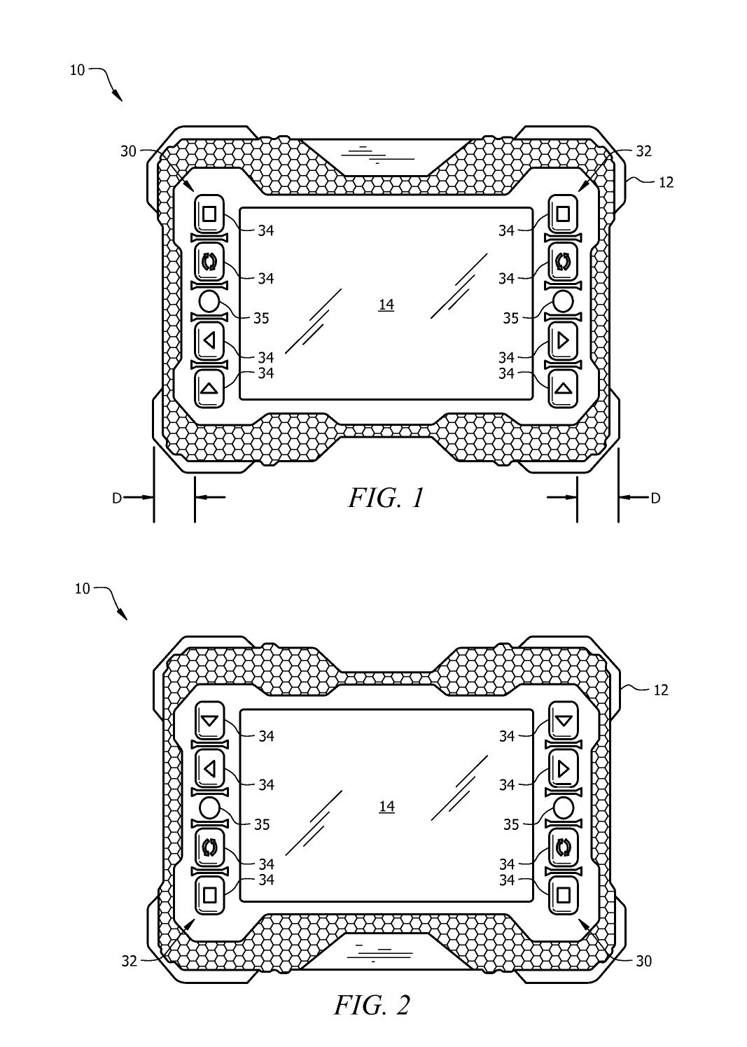

FIGS. 1-7 depict an embodiment of a mobile computing device in the form of a tablet computer, or tablet 10. The tablet 10 comprises a housing 12 formed from an impact-resistant material such as aluminum or high-impact plastic. The tablet 10 also includes a rectangular display 14 that is positioned within, and is viewable through an opening in the housing 12. The display 14 can be, for example, a flat-panel liquid crystal display (LCD) such as a character LCD that is capable of presenting text and symbols, or a graphical LCD that is capable of presenting images, video, and graphical user interfaces (GUI). Other types of displays, such as flat panels, solid state displays, displays based on organic light emitting diodes (OLED) or electronic inks, etc., can be used in the alternative. The display 14 can have a shape other than rectangular in alternative embodiments. Alternative embodiments can also include a glass panel, located above the display 14, with a capacitive or resistive overlay to facilitate touch-screen user input.

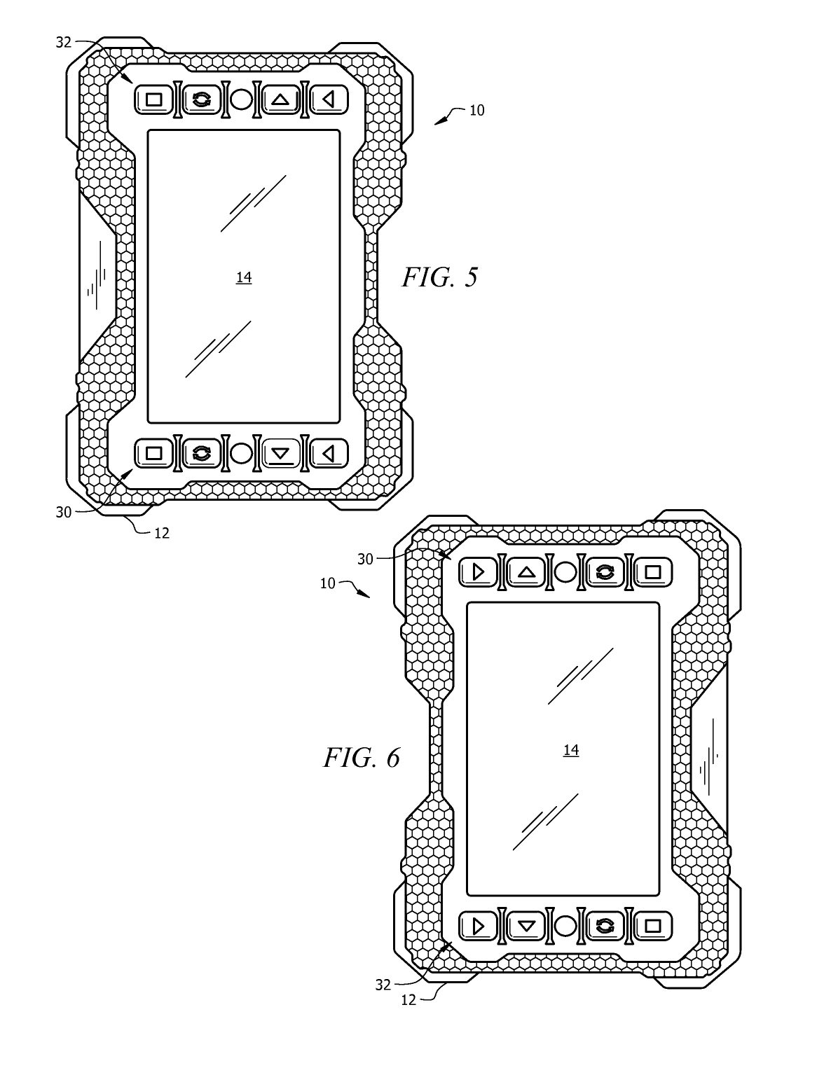

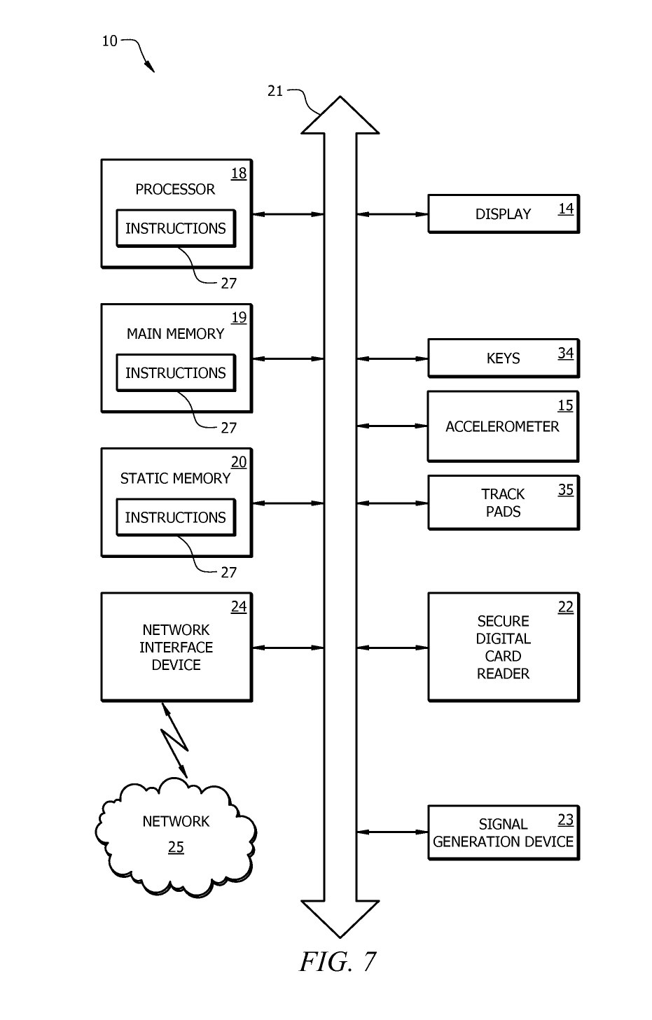

The tablet 10 is configured so that the image on the display 14 can be displayed in both a landscape format in which the width of the image is greater than its height as shown in FIGS. 1-4, and a portrait format in which the height of the image is greater than its width as depicted in FIGS. 5 and 6. The tablet 10 can include an orientation sensor, such as an accelerometer 15 shown in FIG. 7, that senses the orientation of the tablet 10. The tablet 10 is configured so that the image on the display 14 is displayed right-side up in landscape orientation when the tablet 10 is oriented as shown in FIGS. 1, 3, and 4, and right-side up in portrait orientation when the tablet 10 is oriented as shown in FIG. 5. The image on the display 14 is displayed right-side up when the tablet 10 is in a landscape orientation, depicted in FIG. 2, that is angularly offset by 180° from the orientation depicted in FIGS. 1, 3, and 4. The image is displayed right-side up when the tablet 10 is in a portrait orientation, depicted in FIG. 6, that is angularly offset by 180° from the orientation depicted in FIG. 5.

As shown in FIG. 7, the tablet 10 includes a processor 18, such as a central processing unit (CPU), a graphics processing unit (not shown), a main memory 19, and a static memory 20, which communicate with each other via a bus 21. The tablet 10 also a Secure Digital (SD) card reader 22, a signal generation device 23, e.g., a speaker or remote control, and a network interface device 24 that facilitates communication with a network 25.

The static memory 20 stores one or more sets of instructions 27, e.g., software code, configured to implement one or more of the methodologies, procedures, or functions described herein. The instructions 27 can include the above-noted graphics driver for controlling the visual output of the display 14. The instructions 27 can also reside, completely or at least partially, within the main memory 19 or the processor 18 during execution thereof by the tablet 10. The main memory 19 and the processor 18 also can constitute machine-readable media.

Those skilled in the art will appreciate that the computer system architecture illustrated in FIG. 7 is one possible example of a mobile computing device configured in accordance with the inventive concepts disclosed herein. However, the invention is not limited in this regard and any other suitable computer system architecture can also be used without limitation. Moreover, the inventive concepts can be applied in mobile computing devices other than tablet computers.

The tablet 10 comprises a first and a second array 30, 32 of input devices. The input devices can include pushbuttons or keys 34 and touch-sensitive track pads 35 that facilitate user inputs to the tablet 10. As discussed below, the display 14 of alternative embodiments can be a touch-sensitive screen that further facilitates user inputs. The keys 34 and track pads 35 are communicatively coupled to the processor 18 of the tablet 10 via the bus 21. In alternative embodiments, the first and second arrays 30, 32 can each be a touch-sensitive screen equipped to display graphical function keys and a graphical touchpad equivalent to the physical keys 34 and track pads 35 of the first and second arrays 30, 32.

The keys 34 and track pad 35 in each array 30, 32 are arranged in rows, as depicted in FIGS. 1-6. The rows are vertically orientated when the tablet 10 is oriented for viewing in the landscape mode. The track pad 35 in each array 30, 32 is positioned in the middle of the array 30, 32, i.e., two of the buttons 34 are positioned above, and two of the buttons 34 are positioned below the tack pad 35 when the tablet 10 is oriented in the landscape mode as shown in FIGS. 1-4. The track pads 35 can be positioned in other relative locations within the first and second arrays 30, 32 in alternative embodiments. Moreover, the first and second arrays 30, 32 of alternative embodiments can be configured with more or less than four buttons 34 and one track pad 35.

Each key 34 and track pad 35 is positioned within, and is accessible to the user through an associated opening in the housing 12. The first and second arrays 30, 32 are substantially identical, i.e., the function of each key 34 and track pad 35 at each location in the first array 30 is the same as that of a corresponding key 34 and track pad 35 at the same relative location in the second array 32.

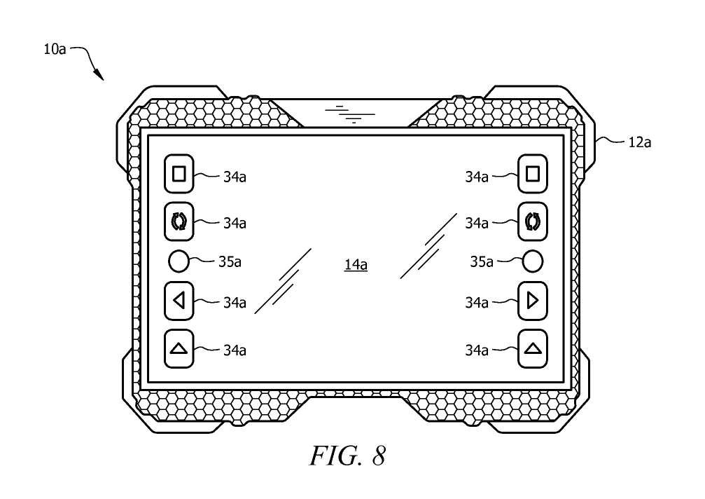

The keys 34 can be any type of pushbutton or key that generates an electrical output in response to being pushed or otherwise actuated. For example, the keys 34 can be mechanical keys, such as rubber dome, membrane, metal contact, or form element keys; or capacitive keys. In alternative embodiments, the display 14 can be a touch-sensitive screen, and graphical function keys and touchpads equivalent to the physical keys 34 and track pads 35 of the first and second arrays 30, 32 can be displayed proximate opposite ends of the touch-sensitive screen. For example, FIG. 8 depicts a tablet 10a comprising a display 14a mounted in a body 12a. The tablet 10a is configured to display a first graphical array 30a of keys 34a and a tack pad 35a on the display 14a, proximate a first end of the display 14a so that the keys 34a and tack pad 35a can be accessed by the thumb of an average adult user. The tablet 10a is configured to display an identical second graphical array 32a of keys 34a and a tack pad 35a on the display 14a, proximate a second end of the display 14a, so that the keys 34a and a tack pad 35a can be accessed by the thumb of the user.

The processor 18, acting in accordance with the instructions 27, recognizes the input from each particular key 34 as a user input corresponding to the particular function associated with that key 34. The four keys 34 in each of the first and second arrays 30, 32 can correspond respectively to the following functions: enter or return; display refresh; cursor movement sideways; cursor movement upward. Alternative embodiments can include additional keys 34 that facilitate input of additional functions such as home, search, etc. The cursor-movement functions are used to navigate a graphically-displayed cursor around one or more menus shown on the display 14. A particular function displayed on the menu is chosen by pressing the enter button while the cursor is positioned over that function.

Each of the track pads 35 is configured to generate an electrical output representative of the direction in which the user moves her or her finger across the track pad 35. The processor 18, acting in accordance with the instructions 27, recognizes this input from the track pad 35 as corresponding to a user command to move the graphically-displayed cursor in a direction on the display 14 corresponding to the direction in which the user's finger is moving across the track pad 35.

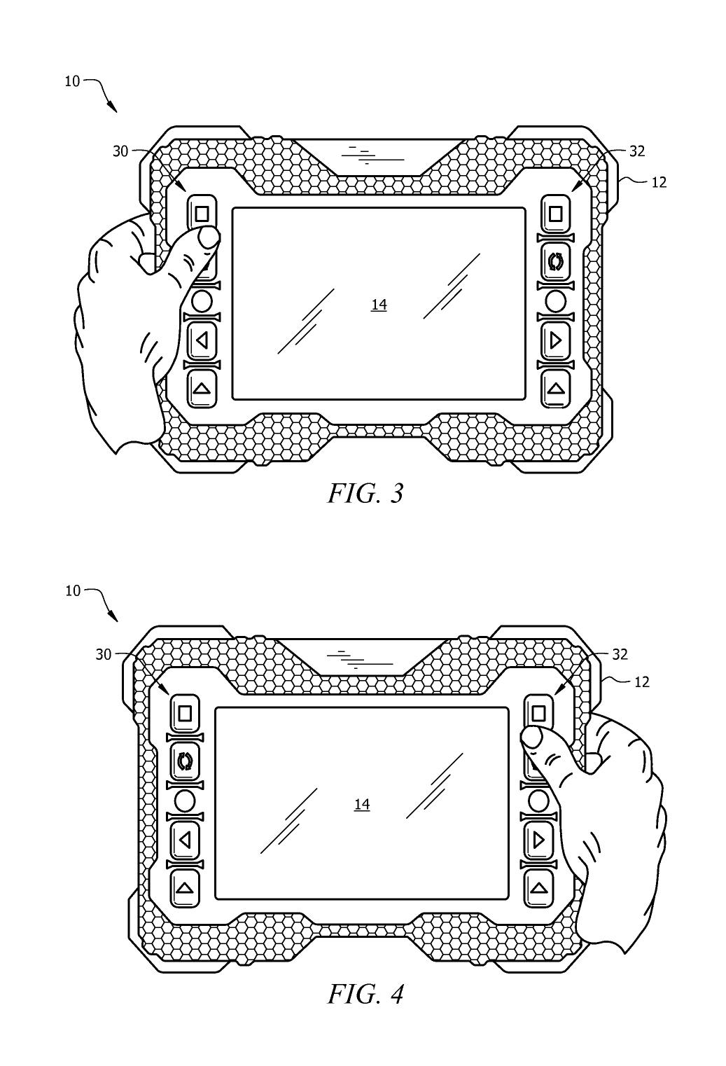

The user can hold the tablet 10 in its landscape orientation with both hands, with one hand located on either side of the housing 12. The tablet 10 can also be held by the user in the landscape orientation with one hand, as depicted in FIGS. 3 and 4. For example, during tactical operations, a soldier may need to grasp and operate the tablet 10 with one hand while holding a weapon or other equipment with the other hand. As another example, an emergency responder such as a firefighter or paramedic may need grasp and operate the tablet 10 with one hand while holding firefighting equipment, medical equipment, or a stretcher in the other hand.

The first and second arrays 30, 32 are located on opposite sides of the display 14 when the tablet 10 is oriented for viewing in the landscape mode. Each array 30, 32 is positioned proximate an associated side of the housing 12, to permit the user to contact the keys 34 and track pads 35 with the thumb or other finger of the user's left and right hands, according to the user's preference. For example, the keys 34 and track pads 35 are spaced apart from their associated side of the housing 12 by a distance “D” of approximately one inch, as denoted in FIG. 1. This feature can facilitate left and right-handed, or “ambidextrous,” operation of the tablet 10, i.e., the user can activate the functions associated with each of the keys 34 and track pads 35 using either the left or right hand when the tablet 10 is oriented for viewing in the landscape mode, as illustrated in FIGS. 3 and 4. Thus, the user has the option of operating the keys 34 and track pads 35 with a preferred hand, without a need to rotate the tablet by 180° or more to position the keys 34 and track pads 35 proximate the preferred hand.

Moreover, the user has the option of operating whichever array 30, 32 is located above or below the display 14 when the tablet 10 is oriented for viewing in the portrait orientation. Thus, if the user prefers to operate the tablet 10 in the portrait orientation with the keys 34 and track pads 35 located below or above the display 14, the user can do so without a need to rotate the tablet by 180° or more regardless of the orientation of the tablet 10.

Thus, regardless of the manner in which the user grasps the tablet 10 in the landscape orientation, the user will be able to use whichever hand he or she prefers at that particular time to activate the functions associated with the keys 34 and track pads 35. In other words, the tablet 10 will always be “right-side up” to the user, and the keys 34 and track pad 35 will always be accessible to the user's preferred hand. This feature can potentially reduce the time needed for a user to remove the tablet 10 from a protective case or other storage device and begin viewing the tablet 10, by eliminating the potential need for the user to rotate the tablet 10 by 180° to position the keys 34 and track pad 35 in a manner that facilitates operation thereof with the user's preferred hand. The ability to quickly access and begin operating the tablet 10 can be of the utmost importance during, for example, combat, firefighting, and rescue operations. The ability to operate the tablet 10 in an ambidextrous manner can be particularly beneficial in darkness and under low-visibility conditions where the user cannot clearly see the front face of the tablet 10 as the user is removing the tablet 10 from its stowed condition.

Moreover, the usability of the tablet 10 in darkness and under low-visibility conditions is believed to be enhanced by the positioning of the track pads 35 in the middle of the first and second arrays 30, 32. Positioning the track pads 35 in this manner can provide the user with a tactile indication of the location of the track pads 35, which in turn can provide a reliable non-visual reference to the respective locations of the keys 34 in the associated array 30, 32 since the keys 34 are located symmetrically about their associated track pad 35.

The tablet 10 is advantageously configured so that the buttons 34 in the first and second arrays 30, 32 can be “reprogrammed” by the user to perform secondary functions. In particular, the processor 18, acting in accordance with the instructions 27, can recognize a particular sequence of key strokes or other type of manipulation of a particular key in one of the arrays 30, 32 as an indication that any inputs from the keys 34 of particular array 30, 32 thereafter will correspond to secondary functions, i.e., functions other than the primary functions of return, refresh, cursor sideways, cursor up, home, and search. The secondary functions can include, for example, display black-out, wake up, and power down. The key manipulations that trigger the secondary key functions can be, for example, two or more strokes of a particular key 34 in quick succession, holding down a particular key 34 for a predetermined time period, etc. This feature can facilitate the use of additional keyed functions, while still providing the user with the option to use the tablet 10 in an ambidextrous manner.

We claim:

1. A mobile computing device, comprising:
a housing;
a display mounted on the housing;
a processor;
a first array of input devices communicatively coupled to the processor and positioned proximate a first side of the housing, each of the input devices being operable to generate an output when actuated, wherein the processor is operable to associate the output of each of the input devices with a function; and
a second array of the input devices communicatively coupled to the processor and positioned proximate a second side of the housing, each of the input devices in the second array being operable to generate an output when actuated, wherein: the second array is substantially identical to the first array; and the processor is operable to associate the output of each of the input devices in the second array with a function that is the same as the function associated with the input device at the same relative location in the first array.

2. The mobile computing device of claim 1, wherein the processor is further operable to interpret a predetermined sequence of inputs from one or more of the input devices of the first array as a command to change the functions with which the input devices of the first array are associated.

3. The mobile computing device of claim 2, wherein the processor is further operable to interpret the predetermined sequence of inputs from one or more of the input devices of the second array as a command to change the functions with the input devices of the second array are associated.

4. The mobile computing device of claim 1, wherein:
the display is substantially rectangular; and
the first and second arrays are linear arrays each oriented in a direction substantially perpendicular to a lengthwise direction of the display.

5. The mobile computing device of claim 4, wherein the first and second sides of the housing are configured to extend generally in a direction substantially perpendicular to the lengthwise direction of the display.

6. The mobile computing device of claim 4, wherein the computing device is configured to display a visual output in a first landscape orientation, and a second landscape orientation that is angularly offset from the first landscape orientation by approximately 180°.

7. The mobile computing device of claim 6, wherein the display is further operable to display the visual output in a first portrait orientation angularly offset from the first landscape orientation by approximately 90°, and in a second portrait orientation angularly offset from the first portrait orientation by approximately 180°.

8. The mobile computing device of claim 1, wherein the input devices of each of the first and second arrays comprise a plurality of keys and a track pad.

9. The mobile computing device of claim 8, wherein an equal number of the keys are positioned on each side of the track pad in each of the first and second arrays.

10. The mobile computing device of claim 1, wherein the input devices of each of the first and second arrays are graphically displayed on the display.

11. The mobile computing device of claim 1, wherein the input devices in the first array are spaced apart from the first side of the housing by a distance no greater than approximately one inch; and the input devices in the second array are spaced apart from the second side of the housing by a distance no greater than approximately one inch.

12. The mobile computing device of claim 1, further comprising a memory communicatively coupled to the processor, and instructions stored on the memory and configured to be executed by the processor, wherein the processor is operable to associate the output of each of the input devices in the second array with the function that is the same as the function associated with the input device at the same relative location in the first array in response to execution of the computer-executable instructions.

13. A mobile computing device, comprising:
a housing;
a display mounted on the housing;
a plurality of input devices mounted on the housing and arranged in a first and a substantially identical second array, wherein: the first and second arrays are positioned on opposite sides of the display; each of the input devices is operable to generate an output when actuated, the output corresponding to a function; and the mobile computing device is configured so that each of the input devices in the first array is functionally equivalent to a corresponding one of the input devices located at substantially the same relative location in the second array.

14. The mobile computing device of claim 13, further comprising a processor communicatively coupled to the input devices, a memory communicatively coupled to the processor, and instructions stored on the memory and configured to be executed by the processor, wherein the processor and the instructions are configured so that the processor, in response to execution of the instructions, associates the output of each of the input devices with a function, and associates the output of each of the input devices in the second array with a function that is the same as the function associated with the input device at the same relative location in the first array.

15. The mobile computing device of claim 14, wherein the processor and the instructions are further configured to interpret a predetermined sequence of inputs from one or more of the input devices of the first array as a command to change the functions with which the input devices of the first array are associated.

16. The mobile computing device of claim 13, wherein the processor is further configured to interpret the predetermined sequence of inputs from one or more of the input devices of the second array as a command to change the functions with the input devices of the second array are associated.

17. The mobile computing device of claim 13, wherein:
the display is substantially rectangular; and
the first and second arrays are linear arrays each oriented in a direction substantially perpendicular to a lengthwise direction of the display.

18. The mobile computing device of claim 13, wherein the input devices of each of the first and second arrays comprise a plurality of keys and a track pad.

19. The mobile computing device of claim 18, wherein an equal number of the keys are positioned on each side of the track pad in each of the first and second arrays.

20. The mobile computing device of claim 13, wherein the input devices of each of the first and second arrays are graphically displayed on the display.

21. A method for operating a mobile computing device, comprising:
providing a functional input to the computing device by actuating a first input device of the computing device located proximate a right side of the computing device using a finger of the right hand while holding the computing device in a first orientation; and
providing the same functional input to the computing device by actuating a second input device located proximate a left side on the computing device using a finger of the left hand while holding the computing device in the first orientation.

22. The method of claim 21, wherein:
actuating a first input device of the computing device located proximate a right side of the computing device using a finger of the right hand while holding the computing device in a first orientation comprises depressing a first key of the computing device; and
actuating a second input device located proximate a left side on the computing device using a finger of the left hand while holding the computing device in the first orientation comprises depressing a second key of the computing device.

23. The method of claim 21, wherein:
actuating a first input device of the computing device located proximate a right side of the computing device using a finger of the right hand while holding the computing device in a first orientation comprises actuating the first input device using the finger of the right hand while holding the computing device in the first orientation using the right hand; and
actuating a second input device of the computing device located proximate a left side of the computing device using a finger of the left hand while holding the computing device in the first orientation comprises actuating the second input device using the finger of the left hand while holding the computing device in the first orientation using the left hand.

24. The method of claim 21, further comprising: providing the same functional input to the computing device by actuating the first input device using a finger of the left hand while holding the computing device in a second orientation angularly offset from first orientation by approximately 180°.

25. The method of claim 21, further comprising: providing the same functional input to the computing device by actuating the second input device using a finger of the right hand while holding the computing device in a second orientation angularly offset from first orientation by approximately 180°.
